(19) United States
(12) Patent Application Publication
(10) Pub. No.: US 2020/0202608 A1
(43) Pub. Date: Jun. 25, 2020

(54) METHOD AND APPARATUS FOR RECEIVING A VOLUMETRIC VIDEO STREAM

(71) Applicant: Point Cloud Compression, B.V., Amsterdam (NL)

(72) Inventor: Rufael Negatu Mekuria, Amsterdam (NL)

(73) Assignee: Point Cloud Compression, B.V., Amsterdam (NL)

(21) Appl. No.: 16/229,876

(22) Filed: Dec. 21, 2018

(51) Int. Cl. G06T 15/08; H04L 29/06; G06T 7/60; G06T 7/90; G06T 7/40

(52) U.S. Cl. CPC G06T 15/08; H04L 65/607; H04L 65/608; G06T 2207/10028; G06T 7/90; G06T 7/40; G06T 7/60

(57) ABSTRACT

A method or system (100, 200, or 300) for receiving volumetric video (102) includes receiving (201) a first video track carrying geometry information, receiving (202) a second video track carrying occupancy information, receiving (203) an auxiliary metadata description, and receiving (204) a third track carrying texture information where the first and second video track are combined with the auxiliary metadata description to perform 3D geometry reconstruction to produce one or more geometry position (205). A fourth track is used to reconstruct (206) one or more color attributes corresponding to the one or more geometry positions. The one or more geometry positions and the one or more color attributes are combined to form (207) 3D colored points and rendered (208) as a volumetric video.

### FIELD

The current embodiments relate to data compression and transmission, and more particularly to receiving a volumetric video stream.

### BACKGROUND

A point cloud is a 3D data structure that defines positions of points in 3D space and respective attributes such as colors and material properties. These 3D data structures, can be used to convey a volumetric video stream by rendering the 3D points in space. Volumetric video streams are useful in augmented and virtual reality applications with real and virtual environments. Transmission of volumetric video is challenging due to the high volume of the data, and the many processing operations required. Video steaming is a popular way to consume content, however techniques for receiving volumetric video are not readily available.

### BRIEF DESCRIPTION OF THE DRAWINGS

FIG. 1 is a block diagram illustrating a method and system for receiving a volumetric video stream from a point cloud in accordance with the embodiments;

FIG. 2 illustrates a method of receiving, decoding, and rendering a volumetric video stream in accordance with the embodiments; and

FIG. 3 is a block diagram illustrating yet another system and method for receiving, decoding, and rending a volumetric video stream in accordance with the embodiments.

FIG. 4 illustrates a system for receiving, decoding, and rendering a volumetric video stream in accordance with the embodiments.

### SPECIFICATION

Embodiments herein introduce a method or apparatus or system for receiving a volumetric video stream. Initially, some definitions of terms will provide better understanding of the embodiments:

Volumetric video: is a video technique that captures a three-dimensional space, such as a location or performance. This type of video acquires data that can be viewed on flat screens as well as on 3D Displays, Augmented Reality (AR), Virtual Reality (VR), or mixed reality (MR) goggles or other presentation devices. Volumetric video can be viewed from any angle and from any distance. Sometimes this is referred to as six degrees of freedom video. Further volumetric video can be visualized on top of the real world using augmented reality or in a display and/or virtual world using rendering techniques from computer graphics. Volumetric video typically conveys information about the 3D positions and respective colors and can be represented by point cloud objects which contain information about the 3D positions and the respective attributes such as colors and/or reflectance information. Volumetric video can also be rendered at different sizes and in some cases it is envisioned that it can be used to generate a holographic rendering representation.

Point Cloud: A point cloud is a data representation that specifies a set or collection of geometric positions conveyed as (x, y, z) or any other coordinate system available and respective attributes corresponding to the different positions such as colors (red, green, blue) or any others. Point clouds can specify any position in 3D space and many be obtained by a 3D reconstruction applied to different captured images or by sampling a 3D model such as based on a polygon mesh.

Video track: In our reception model, volumetric video is conveyed using a number of video tracks. Video tracks are sequences of boxes in the ISOBMFF format of box type moof and mdat, an example of a video track is the video track defined in ISO/IEC Common media application format. These boxes contain the compressed frames as samples in the mdat box. The video tracks can be received using any adaptive streaming protocol, but they do have the structure of moof and mdat boxes in the ISOBMFF format. The video tracks are regular video tracks such as coded using H.264/AVC as defined by ISO/IEC or H.265/HEVC or next generation video codecs such as AV1 developed by alliance for open media or versatile video coding (vvc) under development in MPEG.

Geometry information: The geometric information refers to the positions of points in a 3D space, this can be based on (x, y, z) positions or any coordinate information in 3D space. The geometric information is the part of the point cloud excluding the attribute information.

Occupancy information: Information that signals if points in video frame, conveyed in a video track correspond to a 3D position in the 3D point cloud data. This occupancy information is needed to detect pixels in images that need to be used in the 3D reconstruction phase to map back the point positions and colors. Occupancy information can be binary as either a pixel corresponds to a 3D position or not. In case occupancy information is conveyed in a video frame it may also be referred to as an occupancy map.

Auxiliary metadata description: Auxiliary meta-data description can contain information related to the different patches or projections such as an index to a chosen projection plane, the 2D bounding boxes and information of 3D information of the patch based on depth, tangential shift and bi-tangential shift from the projected patch. The size of the patch K×K can also be signalled. By storing this list of patch information, the 3D geometry can be reconstructed from the geometry images and texture images. A patch is a small part of the point cloud or volumetric stream with similar properties mapped to a single projection plane stored in an a video frame in the track. This auxiliary data is used to map back the patch pixels to 3D positions, the depth information and shifts can be used to compute the 3D patch from the patch projected as a 2D frame in the image. For example in case patch based projection are used the auxiliary information can contain the following for each patch:
Index of the projection plane e.g.
   Index 0 for the planes (1.0, 0.0, 0.0) and (-1.0, 0.0, 0.0)
   Index 1 for the planes (0.0, 1.0, 0.0) and (0.0, -1.0, 0.0)
   Index 2 for the planes (0.0, 0.0, 1.0) and (0.0, 0.0, -1.0)
2D bounding box (u0, v0, u1, v1)
3D location (x0, y0, z0) of the patch represented in terms of depth δ0, tangential shift s0 and bi-tangential shift r0. According to the chosen projection planes, (δ0, s0, r0) are computed as follows:
   Index 0, δ0=x0, s0=z0 and r0=y0
   Index 1, δ0=y0, s0=z0 and r0=x0
   Index 2, δ0=z0, s0=x0 and r0=y0
      In practice this information may be further compressed using entropy coding schemes and differential coding schemes, for example using golomb rice coding.

Texture information: Texture mapping is a method for defining high frequency detail, surface texture, or color information on a computer-generated graphic or 3D model.

Texture mapping originally referred to a method (now more accurately called diffuse mapping) that simply wrapped and mapped pixels from a texture to a 3D surface. In recent decades the advent of multi-pass rendering and complex mapping such as height mapping, bump mapping, normal mapping, displacement mapping, reflection mapping, specular mapping, mipmaps, occlusion mapping, and many other variations on the technique (controlled by a materials system) have made it possible to simulate near-photorealism in real time by vastly reducing the number of polygons and lighting calculations needed to construct a realistic and functional 3D scene. In this disclosure the texture information refers to the colors (r, g, b) of the point cloud or volumetric stream that is projected back to video frames in the video track that that are received. The video frames that contain the information relating to the colors is referred as the texture information.

Geometry reconstruction: In this disclosure 3D reconstruction refers to obtaining back the 3D positions and color attributes from the 2D data conveyed in the video tracks. Different operations in the 3D reconstruction can include rigid body transform, scaling of pixels, blending pixels and spatial shiftings. The geometry reconstruction implies an inverse mapping from 2D data conveyed in the video tracks to the volumetric video stream or point cloud. Given the original mapping was done using patches, auxiliary metadata information and occupancy information can be used in the reconsruction. For example, occupied pixels in patches are mapped back to 3D position using the depth information, the projection index and the tangential and bi-tangential shift information.

Geometry positions: In geometry the orientation, angular position, or attitude of an object such as a line, plane or rigid body is part of the description of how it is placed in the space it occupies. Namely, it is the imaginary rotation that is needed to move the object from a reference placement to its current placement. A rotation may not be enough to reach the current placement. It may be necessary to add an imaginary translation, called the object's location (or position, or linear position). The location and orientation together fully describe how the object is placed in space. The above-mentioned imaginary rotation and translation may be thought to occur in any order, as the orientation of an object does not change when it translates, and its location does not change when it rotates. In general the position and orientation in space of a rigid body are defined as the position and orientation, relative to the main reference frame, of another reference frame, which is fixed relative to the body, and hence translates and rotates with it (the body's local reference frame, or local coordinate system). At least three independent values are needed to describe the orientation of this local frame. Three other values are all the points of the body change their position during a rotation except for those lying on the rotation axis. If the rigid body has rotational symmetry not all orientations are distinguishable, except by observing how the orientation evolves in time from a known starting orientation. For example, the orientation in space of a line, line segment, or vector can be specified with only two values, for example two direction cosines. Another example is the position of a point on the earth, often described using the orientation of a line joining it with the earth's center, measured using the two angles of longitude and latitude. Likewise, the orientation of a plane can be described with two values as well, for instance by specifying the orientation of a line normal to that plane, or by using the strike and dip angles. There are a number of mathematical methods to represent the orientation of rigid bodies and planes in three dimensions. The geometry positions can be quantized representing entries in voxel grids.

Color attributes: color attributes can include, but are not limited to hue, saturation, brightness, temperature, contrast, transparency, gamma, and in some instances resolution, and aspect ratio. Typical color attributes could be colours red green blue space or chrominance luminance. Color attributes correspond to positions in 3D space (geometry information), the combined geometry information with color attribute information is colored 3D point information.

Colored 3D points: Colored 3D points are points formed by obtaining and combining one or more geometry positions with one or more color attributes to obtain a plurality of colored 3D points. These colored 3D points can be rendered, for example, using a web renderer, or a the game engine or some other form of game engine technology.

Adaptive streaming protocol: An adaptive streaming protocol detects the bandwidth of a receiver network connection and central processing unit (CPU) capacity in real time and adjusts the bit rate or quality level of the live streams accordingly. Examples of Adaptive streaming protocols include MPEG DASH defined in ISO/IEC 23009-1 and HLS defined in RFC 8286. An adaptive streaming protocol allows a receiver to download segments of media content using HTTP GET requests.

Encrypted fragments: In some embodiments can be combinations of movie fragment (moof) and media data container (mdat) boxes (as defined in ISOBMFF, for example) to enclose a piece of decodable media data into video tracks that is in an encrypted format. This encryption can be performed using Advanced Encryption Standard (AES) with schemes such as CTR and CBCs defined. ISO/IEC Common Encryption (CENC) defines how these encryption techniques can be applied and signaled on media fragments in ISO Base Media File Format (ISOBMFF). Examples of such modes include cbcl and cenc that encrypt the sample data of the fragment. Alternatively, cbcs and cens only encrypt parts of the sample data, reducing computational overhead and making it easier to inspect configuration data.

On-the-fly generated fragments: In some embodiments, on-the-fly generated fragment can include fragments generated by a dynamic packager or an on-the-fly packager which generates fragments from a first container format to a second container format.

Dynamic packager: A dynamic packager can be an On-the-fly packager which typically includes the functionality of packaging a stream from a first container format to a second container format. In addition, the on-the-fly packager can have functionalities for retrieving encryption information and performing encryption to different samples enclosed in the video track. In addition, they can generate the streaming manifests as necessary for the streaming presentation. Such on-the-fly packager can generate different streaming formats from a single input source. For example, fragmented MPEG-4 ISOBMFF can be used to generate streaming presentations like based on MPEG DASH and HLS. Examples of embodiments of such on-the-fly packagers include Unified Origin as developed and sold by Unified Streaming platform, or competing products with similar functionalities.

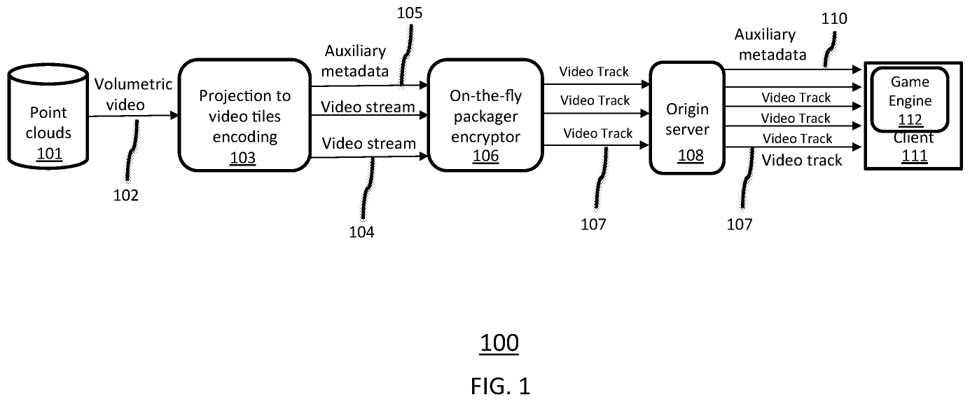

In some embodiments, the method for receiving volumetric video based on video tracks uses some existing video streaming technologies and components which should help in quickly expanding the market for receiving volumetric video. The embodiments include reception, decryption and visualization of data. Compression and transmission of 3D point clouds and volumetric video remains challenging. Referring to FIG. 1, volumetric video streams 102 from a point cloud 101 in a system 100 can contain the visual information and additional geometric information making them suitable for rendering 3D scenes such as in augmented and/or virtual reality. Some of the other 3D data structure representations used for volumetric video include 3D point clouds, 3D meshes and 3D light fields. Recently, point clouds have become popular for conveying a volumetric video. However, point clouds and volumetric streams need a lot of data to be represented effectively. While some progress is made in the compression and compact representation of point clouds, receiving a point cloud or volumetric video stream is still challenging in current network architectures. For reception, the download of media content, the decoding and decryption of content are important.

One of the main problems besides compression of point cloud data is how to convey this information for efficiently receiving it at mobile clients, consumer devices, computers and other terminals in the digital eco-system. Existing technologies and standards such as ISO/IEC ISO base media file format (ISOBMFF) and streaming technology using adaptive streaming protocols do not support volumetric video representations. Further, encryption of the volumetric video and point cloud data is still a challenge that needs to be addressed for allowing secure and authorized delivery of such contents, for example when digital rights management is needed. Volumetric video streams so far cannot re-use existing technologies available to the consumer end device for decrypting media streams such as the media source extension (MSE) implemented in many of the browsers as new schemes for encryption would be required. Another aspect that considers attention when receiving point cloud or volumetric video streams is the post-processing of the content for better visualization and 3D rendering. The post processing is required to deal with lossy point cloud compression formats that introduce compression artefacts. This is a key aspect of receiving volumetric video or point cloud data in a way that is pleasant for the final user experience. For example, outlier points, or duplicate points may need to be removed, or noise points introduced by the compression scheme need to be removed. Direct visualization of such streams may introduce severe artefacts leading to a bad quality experience for the end users. To address these challenges, the embodiments disclose a method for receiving a volumetric video stream, such as a point cloud stream at a client that addresses each of these aspects. Contrary to prior work, the embodiments can be integrated easily in current ecosystems of media encoders, clients and processors, as it is based on combining some of the existing media technologies in a non-trivial and unconventional way. It is understood that the explanations, graphics are merely examples of the presently disclosed embodiments and someone skilled in the art may implement them in a different way which would still be within the scope of the claimed embodiments.

Firstly, volumetric video streams such as based on point clouds may be represented compactly using multiple video streams, each carrying information about different aspects of the stream such as geometric (depth) information, texture information and occupancy information conveyed as occupancy maps. The occupancy map signals which pixels in the mapped image represent 3D data points. In addition, Auxiliary metadata description needs to be received in order to reconstruct the point cloud or volumetric video correctly. Prior to transmission and encoding the point cloud or volumetric video surfaces can be segmented in different local areas with similar surface properties such as normal, these local subsets of the surface are referred to as surface patches. These patches can be small subparts of the surface that can then be mapped to image information by mapping the patches to the image grid via projection (103). This patch based approach is under consideration in emerging MPEG standards for point cloud compression.

These patches can then be encoded by video codecs such as MPEG High Efficiency Video Coding, MPEG Advanced video coding or other emerging video coding standards such as Versatile Video Coding and AV1 defined by Alliance for Open Media. Alternative projection methods may also be used such as by projecting parts of the volumetric to rectangular, spherical or cylindrical surfaces. In a preferred embodiment the video tracks received contain patches or partial information of the volumetric video stream (104). This information can then be packed at 105 to different video tracks 107 to be received by a client or end user device 111.

To summarize, the different resulting compressed videos may contain information relating to the texture and/or color attributes of the volumetric video or point cloud content. The occupancy map information signal if pixels in the images correspond to a point in the image and 3D space (the geometric positions (e.g. depth information)). Further the synchronization of depth and texture data when transmitted over different connections proves to be difficult, hence research in this area was performed by [Huang et al MMSYS 2011]. By not having signaling of how the data is conveyed, rendered decoded at the timelines of the media, 3D reconstruction can fail and latency could be introduced for buffering operations and/or error recovery.

The method disclosed teaches the combination of ISOBMFF format fragments as specified in ISOBMFF MPEG-4 part 12, which are combinations of movie fragment (moof) and media data container (mdat) boxes (as defined in ISOBMFF) to enclose a piece of decodable media data into video tracks. The sequence of movie fragment moof and media data container mdat boxes for a single video track 107 where the different fragments follow each other with increasing sequence order numbering (defined in the media fragment header “mfhd” in the ISOBMFF), and /or increasing decode times signaled in the time fragment decode time “tfdt” box corresponding to ISOBMFF is referred to as a video track. The video track may contain encoded video data as samples such as based on MPEG-4 part 10 advanced video coding, or high efficiency video coding (HEVC) or other video coding technologies. Other video coding formats are not excluded as long as they can be carried using a fragmented MPEG-4 structure using ISOBMFF using a fragment structure of moof and mdat.

The sender may deliver the individual video tracks to enable the client receiving the video tracks through an adaptive streaming protocol. An adaptive streaming protocol detects the bandwidth of the receiver network connection and central processing unit (CPU) capacity in real time and adjusts the bit rate or quality level of the live streams accordingly. In one or more embodiments, the client receives segments utilizing the MPEG DASH protocol. However, it should be noted that the embodiments are not limited to this and alternative streaming protocols may be used, such as without limitation, HTTP Live Streaming (HLS) as defined in RFC 8216 by the IETF, Adobe's Real Time Messaging Protocol (RTMP), Microsoft® Smooth Streaming protocol, and so forth. In case a representation of a video track in a client manifest could be encapsulated as a representation in an adaption set including the representation for download. Fragments formatted in accordance with the fragmented MP4 format (fMP4) based on Part 12 of the MPEG-4 standard which defines ISO Base Media File Format. In many adaptive streaming protocols, the different video tracks are encoded at various bit rates and each bit rate stream is segmented into cacheable-sized fragments that are streamed. The fragments may contain approximately two seconds of content, or more in some cases. By streaming a set of video tracks with different bit-rates, the content provider is able to provide a consumer with a quality viewing experience where the playback device of the media consumer can select the media fragments of a quality level that suits the capabilities of the computing resources in their respective environment.

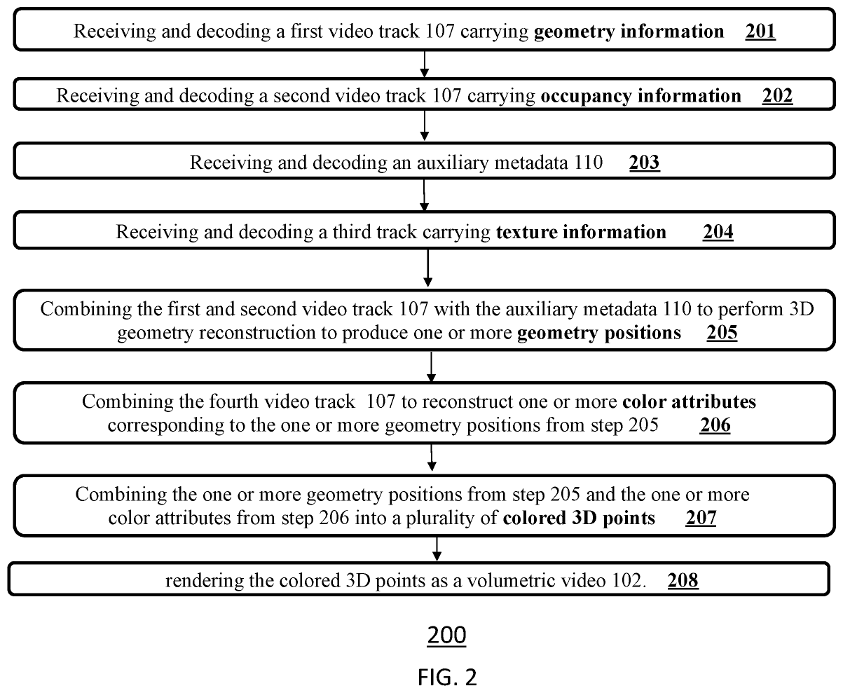

The receiving of a volumetric stream requires receiving more than three video tracks, possibly by using one of the streaming protocols and download the different fragments from an origin server such as origin server 108. The fragments then need to be decoded and the correct function/role of the video tracks and the content need to be identified. The auxiliary metadata description 110 is used to map back the pixels to 3D geometry positions (See step 205 in FIG. 2).

The Auxiliary meta-data description can contain information related to the different patches or projections such as an index to a chosen projection plane, the 2D bounding boxes and information of 3D information of the patch based on depth, tangential shift and bi-tangential shift from the projected patch. The size of the patch K×K can also be signaled per patch. By storing this list of patch information, the 3D geometry can be reconstructed from the geometry images and texture images and the occupancy maps.

The decoding step may also include unencrypting the content in the video track such as using common encryption as defined in MPEG Common encryption in ISO base media file format files (ISO/IEC 23001-7:2016) and parts of the fragment can be encrypted using the

Advanced Encryption Standard (AES) in one of several modes such as “cenc” mode or “cbcs” mode as defined in the ISO/IEC 23001-7:2016.

In preferred embodiments the video tracks could be formatted according to the specification common media application format (CMAF) that defines video tracks as sequences of moof mdat structures in a fragmented mp4 format conforming to the ISOBMFF standard. The Common Media Application format also defines several profiles.

To make sure the timelines of the media presentations align, they can use a common timeline starting from zero, the same timescale or an integer multiple difference for different tracks enabling aligned switching points for switching the representation. These switching points can be achieved by using the same time length for fragments in the different video tracks, making sure the fragment boundaries are sample aligned.

The auxiliary and metadata information (105 and 110) also can signal the function of each of the streams and information for performing the 3D geometry reconstruction as required to correctly receive and render the volumetric video stream. This information includes the projection plane for the projected points in the video track in each part of the video, the dimension of the patches, which are subparts of the video corresponding to geometric regions (K×K) and the 3D information of the patch when it is signaled relatively to the projection plane using depth and tangential shift.

In some embodiments, a client 111 can include a game engine 112 and the client can decrypt, decode and/or reconstruct volumetric video 102 Referring to FIG. 2, in some embodiments, a method 200 of rendering volumetric video 102 at the client 111 can include the step 201 of receiving and decoding a first video track 107 carrying geometric information and the step 202 of receiving and decoding a second video track 107 carrying occupancy information. At step 203, the method 200 can receive and decode auxiliary metadata 110. At step 204, the method 200 can receive and decode a third track carrying texture information. The first and second video tracks 107 can be combined with the auxiliary metadata 110 to perform 3D geometry reconstruction to produce one or more geometry positions at 205. At step 206, the method combines a fourth video track 107 (with the other video tracks and the auxiliary metadata) to reconstruct one or more color attributes corresponding to the one or more geometry positions produced at step 205. The method forms a plurality of colored 3D points at step 207 by combining the one or more geometry position from step 205 with the one or more color attributes from step 206. At step 208, the 3D colored points are rendered as a volumetric video 102.

A plurality of colored 3D points can be formed at 207 by obtaining and combining one or more geometry positions at 205 with the one or more color attributes at 206. These colored 3D points from step 207 can then be rendered, for example, using a web renderer, the game engine 112 or some other form of game engine technology for interacting with the volumetric video stream.

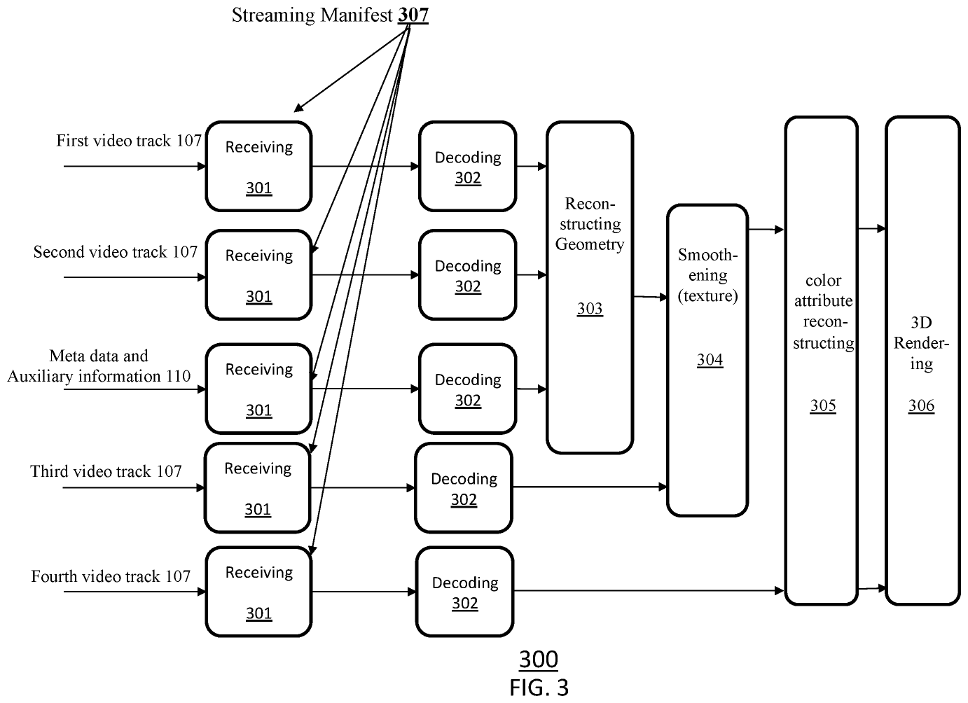

In some embodiments, a method 200 (FIG. 2) or system 100 (FIG. 1) for receiving volumetric video 102 from a point cloud 101 can include receiving and decoding a first video track 107 carrying geometry information; receiving and decoding a second video track 107 carrying occupancy information; receiving and decoding an auxiliary metadata description 110; receiving and decoding a third video track 107 carrying texture information; combining the first and second video track with the auxiliary metadata description to perform 3D geometry reconstruction to produce one or more geometry positions (205); combining the fourth video track 107 to reconstruct one or more color attributes (206) corresponding to the one or more geometry positions. Combining the one or more geometry positions and the one or more color attributes into a plurality of colored 3D points (207); and rendering (208) the colored 3D points as a volumetric video 102. The one or more of the video tracks 107 can be received using an adaptive streaming protocol by reading a Streaming Manifest 307 (see FIG. 3) and downloading the segments indicated by URLs in this manifest using HTTP Get Requests.

The method or system 300, in some embodiments, features one or more of the video tracks 107 being received at 301 using an adaptive streaming protocol, where the video tracks are normal video tracks in an adaptive streaming presentation. wherein some embodiments, the one or more video tracks 107 are downloaded based on information in a streaming manifest 307. In some embodiments, the streaming manifest 307 can contain URLs to download the individual media fragments composing the media tracks. In some embodiments the fragments are generated on-the-fly by a dynamic packager (such as on-the-fly packager 106 of FIG. 1) enabling on-the-fly encryption according to an encryption key. Examples of streaming protocols include MPEG dynamic streaming over HTTP (DASH) or HTTP Live Streaming as defined in RFC 8216 (HLS) or any other streaming protocol defined.

Examples of such on-the-fly packagers include Unified Origin as developed by Codeshop B.V. and sold by Unified Streaming B.V., alternatively other on-the-fly packaging and encryption software could be used as available in the market. On-the-fly packagers typically comprises the functionality of packaging a stream from a first container format (104) to a second container format (107). In addition, the on-the-fly packager can have functionalities for retrieving encryption information and performing encryption to different samples enclosed in the video track. In many preferred embodiments the one or more video tracks are encrypted using common encryption as defined for video tracks by ISO/IEC as CENC in international standard ISO/IEC 23001-7:2016.

The fragments will typically use the same segment length, the same timescale, and the same clock source as to enable synchronization of the different video tracks when decoding at 302. In some embodiments the receiving (and decoding) of the volumetric video additionally includes smoothing the texture information at 304, which could be any type of smoothing, such as us dilation filter, nearest neighbor filtering, or using gaussian smoothing filters. In addition, geometry information could be filtered at 303 and example filter operations can include outlier filtering using radius distance to nearest neighbor filter or other type of filtering such as interpolation filters. In some embodiments, the volumetric video includes color attributes, which can be reconstructed at 305. In some embodiments, the video tracks will contain information partitioned in patches of K×K corresponding to different regions of the volumetric video or point cloud. These patches can be used to reconstruct the different subparts and further by using the auxiliary meta-data to signal specific information. By using these patches, the geometry reconstruction at 303 and texture reconstruction 304 is supported by combining the projections with information in the metadata 110 on the positioning of the patches. In some embodiments, the video tracks contain geometry information about the near and far layers in the point cloud, such as the maximum distance between the nearest and farthest point projected to a side of the image. By projection, different 3D points can map to the same projection points (x, y), by defining a projection image for the nearest and farthest image, both the nearest and farthest pixels are still captured in the image. Hence to capture the geometry and texture information two images are used instead of one image.

Once the reconstruction of the geometry and texture image is completed, the plurality of 3D points can be rendered on a screen at 306 using technologies for rendering of 3D point clouds such as splatting, global illumination etc, or using a game engine such as Unity.

In the above-description of various embodiments of the present disclosure, aspects of the present disclosure may be illustrated and described herein in any of a number of patentable classes or contexts including any new and useful process, machine, manufacture, or composition of matter, or any new and useful improvement thereof. Accordingly, aspects of the present disclosure may be implemented entirely in hardware, entirely in software (including firmware, resident software, micro-code, etc.) or by combining software and hardware implementations that may all generally be referred to herein as a “circuitry,” “module,” “component,”, “electronic apparatus” or “system.” Furthermore, aspects of the present disclosure may take the form of a computer program product comprising one or more computer readable media having computer readable program code embodied thereon.

A computing device or electronic apparatus is further intended to represent various forms of digital computers, such as laptops, desktops, workstations, personal digital assistants, servers, blade servers, main-frames, and other appropriate computers. Computing devices are intended to represent various forms of mobile devices, such as personal digital assistants, cellular telephones, smart phone, and other similar computing devices.

Any combination of one or more computer readable media may be used. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, C++, C#, VB.NET, Python, Vala, GEM, or the like, conventional procedural programming languages, such as the “C” programming language, Visual Basic, Fortran 2003, Perl, PHP, dynamic programming languages such as Python and Ruby or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS) and Security as a Service (SECaaS). Further, the use of virtualization techniques such as using hypervisors based virtualization or operating system level virtualization to implement the proposed schemes is not precluded.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

Any electronic apparatus or circuitry can be used to store and execute the computer program instructions. Examples of such include a mobile phone device, a tablet computing device, a smart watch, a sensor system that includes a memory for storing the computer program instruction and a processing unit for executing the computer program instructions. Alternative electronic apparatus may be dedicated hardware for point cloud processing that use a memory for storing the program instructions and a processing unit for executing instructions.

It is to be understood that the terminology used herein is for the purpose of describing particular embodiments only and is not intended to be limiting of the embodiments. Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of this specification and the relevant art and will not be interpreted in an idealized or overly formal sense unless expressly so defined herein.

The flowchart and block diagrams in the figures illustrate the architecture, functionality, and operation of possible implementations of systems, methods, and computer program products according to various aspects of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular aspects only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Like reference numbers signify like elements throughout the description of the figures.

The corresponding structures, materials, acts, and equivalents of any means or step plus function elements in the claims below are intended to include any disclosed structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The aspects of the disclosure herein were chosen and described in order to best explain the principles of the disclosure and the practical application, and to enable others of ordinary skill in the art to understand the disclosure with various modifications as are suited to the particular use contemplated.

In some embodiments, a system includes at least one memory and at least one processor of a computer system communicatively coupled to the at least one memory. The at least one processor can be configured to perform a method including methods described above.

According yet to another embodiment of the present disclosure, a computer readable storage medium comprises computer instructions which, responsive to being executed by one or more processors, cause the one or more processors to perform operations as described in the methods or systems above or elsewhere herein.

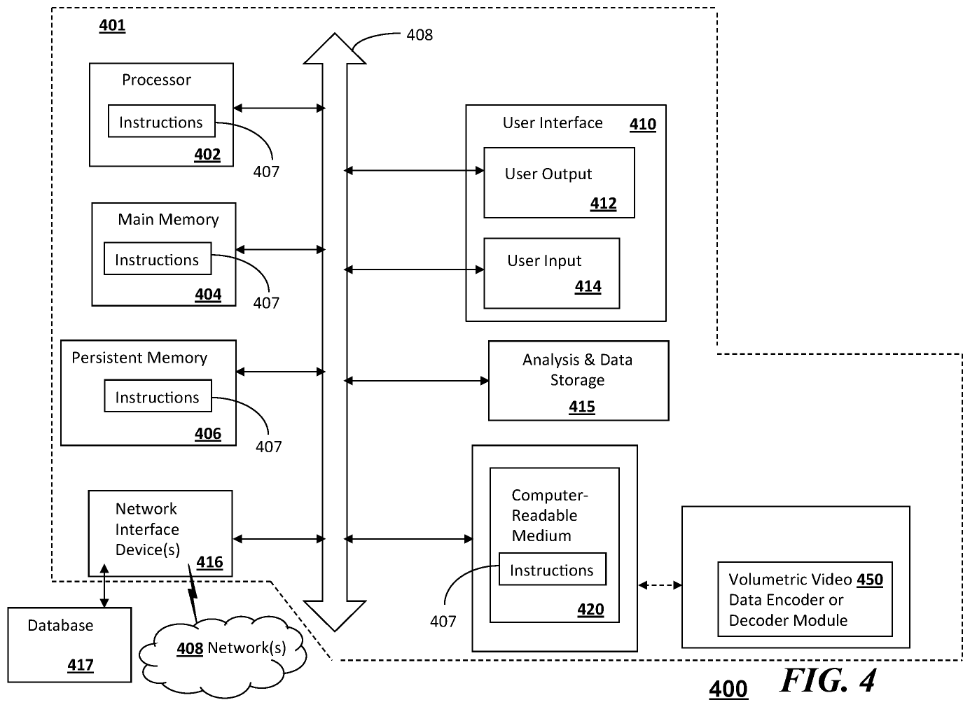

As shown in FIG. 4, an information processing system 401 of a system 400 can be communicatively coupled with the volumetric data stream encoder or decoder 450 and a group of client or other devices, or coupled to a presentation device for display at any location at a terminal or server location. According to this example, at least one processor 402, responsive to executing instructions 407, performs operations to communicate with the module 450 via a bus architecture 408, as shown. The at least one processor 402 is communicatively coupled with main memory 404, persistent memory 406, and a computer readable medium 420. The processor 402 is communicatively coupled with an Analysis & Data Storage 415 that, according to various implementations, can maintain stored information used by, for example, the data analysis module 450 and more generally used by the information processing system 400. Optionally, this stored information can be received from the client or other devices. For example, this stored information can be received periodically from the client devices and updated or processed over time in the Analysis & Data Storage 415. Additionally, according to another example, a history log can be maintained or stored in the Analysis & Data Storage 415 of the information processed over time.

The computer readable medium 420, according to the present example, can be communicatively coupled with a reader/writer device (not shown) that is communicatively coupled via the bus architecture 408 with the at least one processor 402. The instructions 407, which can include instructions, configuration parameters, and data, may be stored in the computer readable medium 420, the main memory 404, the persistent memory 406, and in the processor's internal memory such as cache memory and registers, as shown.

The information processing system 400 includes a user interface 410 that comprises a user output interface 412 and user input interface 414. Examples of elements of the user output interface 412 can include a display, a projection device, VR or AR goggles, a speaker, one or more indicator lights, one or more transducers that generate audible indicators, and a haptic signal generator. Examples of elements of the user input interface 414 can include a keyboard, a keypad, a mouse, a track pad, a touch pad, a microphone that receives audio signals, a camera, a video camera, or a scanner that scans images. The received audio signals or scanned images, for example, can be converted to electronic digital representation and stored in memory, and optionally can be used with corresponding voice or image recognition software executed by the processor 402 to receive user input data and commands, or to receive test data for example.

A network interface device 416 is communicatively coupled with the at least one processor 402 and provides a communication interface for the information processing system 400 to communicate via one or more networks 408. The networks 408 can include wired and wireless networks, and can be any of local area networks, wide area networks, or a combination of such networks. For example, wide area networks including the internet and the web can inter-communicate the information processing system 400 with other one or more information processing systems that may be locally, or remotely, located relative to the information processing system 400. It should be noted that mobile communications devices, such as mobile phones, Smart phones, tablet computers, lap top computers, and the like, which are capable of at least one of wired and/or wireless communication, are also examples of information processing systems within the scope of the present disclosure. The network interface device 416 can provide a communication interface for the information processing system 400 to access the at least one database 417 according to various embodiments of the disclosure.

The instructions 407, according to the present example, can include instructions for receiving, decoding, and rendering or encoding and sending a volumetric video stream and related configuration parameters and data. It should be noted that any portion of the instructions 407 can be stored in a centralized information processing system or can be stored in a distributed information processing system, i.e., with portions of the system distributed and communicatively coupled together over one or more communication links or networks.

FIGS. 1-3 illustrate examples of methods or process flows, according to various embodiments of the present disclosure, which can operate in conjunction with the information processing system 400 of FIG. 4.

What is claimed, is:

1. A method for receiving and rendering volumetric video by one or more processing units, comprising:
receiving and decoding a first video track carrying geometry information;
receiving and decoding a second video track carrying occupancy information;
receiving and decoding an auxiliary metadata description;
receiving and decoding a third video track carrying texture information;
combining the first video track and the second video track with the auxiliary metadata description and occupancy information to perform three dimensional geometry reconstruction to produce one or more geometry positions;
combining the fourth video track with at least one or more of the first video track, the second video track, the auxiliary metadata description or the third video track to reconstruct one or more color attributes corresponding to the one or more geometry positions;
combining the one or more geometry positions and the one or more color attributes into a plurality of colored 3D points; and
rendering the plurality of colored 3D points as a volumetric video using a presentation or projection device.

2. The method of claim 1, where the one or more of the video tracks are received using an adaptive streaming protocol

3. The method of claim 1, where the video tracks are represented by fragments of the same segment length and an integer multiple timescale.

4. The method of claim 4, where the fragments are generated on-the-fly by dynamic packaging of the input video streams.

5. The method of claim 1, where one or more of the video tracks are encrypted using common encryption.

6. The method of claim 1, additionally comprising smoothing the texture information.

7. The method of claim 1, additionally comprising smoothing the geometry information.

8. The method of claim 1, where the information in the one or more video tracks is partitioned in patches corresponding to different geometric regions.

9. The method of claim 1, where the video track carrying geometry information carries two images to represent a near layer projection and a far layer projection of points in the volumetric video.

10. The method of claim 1, where a game engine is used to visualize the volumetric video stream upon rendering.

11. A system for receiving and rendering volumetric video, comprising:
a memory for temporarily storing a plurality of quantized points in 3D space;
one or more processing units being configured to:
receive and decode a first video track carrying geometry information;
receive and decode a second video track carrying occupancy information;
receive and decode an auxiliary metadata description;
receive and decode a third video track carrying texture information;
combine the first video track and the second video track with the auxiliary metadata description to perform three dimensional geometry reconstruction to produce one or more geometry positions;
combine the fourth video track with at least one or more of the first video track, the second video track, the auxiliary metadata description or the third video track to reconstruct one or more color attributes corresponding to the one or more geometry positions;
combine the one or more geometry positions and the one or more color attributes into a plurality of colored 3D points; and
render the plurality of colored 3D points as a volumetric video using a presentation or projection device.

12. The system of claim 11, where the one or more of the video tracks are received using an adaptive streaming protocol

13. The system of claim 11, where the video tracks are represented by fragments of the same segment length and integer multiple timescale.

14. The system of claim 11, wherein the one or processors are further configured for smoothing the texture information.

15. The system of claim 11, wherein the one or processors are further configured for smoothing the geometry information.

16. The system of claim 11, where the video track carrying geometry information carries two images to represent a near layer projection and a far layer projection of points in the volumetric video.

17. The system of claim 11, where a game engine is used to visualize the volumetric video stream upon rendering.

18. A computer program product, comprising:
a nontransitive storage medium, where the computer program product defines processing instructions for decoding a plurality of points in 3D Space, the computer program product, when executed by processing circuitry of a computer, performs a method, the method comprising:
receiving and decoding a first video track of a volumetric video carrying geometry information;
receiving and decoding a second video track carrying occupancy information;
receiving and decoding an auxiliary metadata description from the volumetric video;
receiving and decoding a third video track carrying texture information;
combining the first video track and the second video track with the auxiliary metadata description to perform three dimensional geometry reconstruction to produce one or more geometry positions;
combining the fourth video track with at least one or more of the first video track, the second video track, the auxiliary metadata description or the third video track to reconstruct one or more color attributes corresponding to the one or more geometry positions;
combining the one or more geometry positions and the one or more color attributes into a plurality of colored 3D points; and
rendering the plurality of colored 3D points as a volumetric video using a presentation or projection device.

19. The computer program product of claim 18, where the step of combining the fourth video track comprises combining the fourth video track with the first video track, the second video track, the auxiliary metadata description and the third video track to reconstruct one or more color attributes corresponding to the one or more geometry positions.

20. The computer program product of claim 18, where a game engine within a client device is used to visualize the volumetric video stream upon rendering.
